(19) United States
(12) Patent Application Publication
(10) Pub. No.: US 2004/0141191 A1
(43) Pub. Date: Jul. 22, 2004

(54) Uniform toner development with large toner particles

(75) Inventor: Howard M. Stark, Macedon, NY (US)

Correspondence Address: Geza C. Ziegler, Jr, PERMAN & GREEN, LLP, 425 Post Road, Fairfield, CT, 06824, US

(73) Assignee: Xerox Corporation

(21) Appl. No.: 10/345,704

(22) Filed: Jan. 16, 2003

(51) Int. Cl. G06K 15/14; H04N 1/409

(52) U.S. Cl. 358/1.9; 358/3.26

(57) ABSTRACT

A method for processing a digital image for printing by an image machine includes the steps of identifying image areas of a digital image and identifying an image pattern having image pattern structures therein. After identifying the image areas and the image pattern, the image areas are modified with the image pattern structures to generate converted image areas. The converted images are then merged with the digital image to produce an output digital image to be written on the photoreceptor where the toner of each image area is deposited on the image structures within the image areas in a periodic fashion.

### BACKGROUND OF THE INVENTION

1. Field of the Invention

The present invention generally relates to image development in xerography and, more particularly, to achieving uniform toner distribution on a photoreceptor after development.

2. Brief Description of Related Developments

A major deficiency with powder xerography in comparison with lithography is the amount of resin deposited on the paper in order to achieve adequate pigment density on the paper. The result of this is poor document appearance, i.e. non-uniform gloss and paper curl. Increasing the pigment concentration in the toner and controlling the development such that the proper amount of pigment is deposited will on the average deposit a smaller amount of resin. This is a necessary but insufficient requirement. Uniform distribution of the toner is also required for image quality reasons.

The present invention describes an imaging processing technique designed to achieve a uniform distribution of toner particles on the photoreceptor after toner deposition. Because of the statistical nature of the development process, the distribution of toner particles on a uniformly charged photoreceptor will be non-uniform. The fusing process tends to smoothen out these non-uniformities. Nevertheless, they are often visible giving an undesirable grainy appearance to the image. The use of small toner particles, for example 4 microns, diminishes the appearance of the non-uniformity. However these small particles are undesirable for cost and safety reasons. Larger particles, for example 20 microns, could not be spread out sufficiently by the fuser and the non-uniformity would be visible. If these larger particles were uniformly distributed on the photoreceptor, similar to a halftone pattern, the fuser could better spread out the toner resin thereby reducing the apparent graininess.

In the well-known process of electrophotographic printing, a charge retentive surface, typically known as a photoreceptor, is electrostatically charged, and then exposed to a light pattern of an original image to selectively discharge the surface in accordance therewith. The resulting pattern of charged and discharged areas on the photoreceptor form an electrostatic charge pattern, known as a latent image, conforming to the original image. The latent image is developed by contacting it with a finely divided electrostatically charged colored or black powder known as “toner.” Toner is held on the image areas by the electrostatic charge on the photoreceptor surface. Thus, a toner image is produced in conformity with a light image of the original being reproduced. The toner image may then be transferred to a substrate or support member (e.g., paper), and the image affixed thereto to form a permanent record of the image to be reproduced. Subsequent to development, excess toner left on the photoreceptor is cleaned from the surface.

An important variation to the general principle of development is the concept of “scavengeless” development. The purpose and function of scavengeless development are described more fully in for example, U.S. Pat. No. 4,868,600. In a scavengeless development system, toner is made available to the photoreceptor by means of AC electric fields supplied by electrode structures, commonly in the form of wires extending across the photoreceptor, positioned within the nip between a donor roll and photoreceptor.

A typical “hybrid” scavengeless development apparatus includes, within a developer housing, a transport roll, a donor roll, and an electrode structure. The transport roll operates in a manner similar to a development roll in a conventional development system, but instead of conveying toner directly to the photoreceptor, conveys toner to a donor roll disposed between the transport roll and the photoreceptor. The transport roll is electrically biased relative to the donor roll, so that the toner particles are attracted from the transport roll to the donor roll. The donor roll further conveys toner particles from the transport roll toward the photoreceptor. In the nip between the donor roll and the photoreceptor are the wires forming the electrode structure. During development of the latent image on the photoreceptor, the electrode wires are AC-biased relative to the donor roll to detach toner therefrom so as to form a toner powder cloud in the gap between the donor roll and the photoreceptor. The latent image on the photoreceptor attracts toner particles from the powder cloud, forming a toner powder image thereon.

### SUMMARY OF THE INVENTION

In one embodiment of this invention, a method for processing a digital image for printing by an image machine is disclosed. The method includes the steps of identifying solid area images of each digital image associated with a color and identifying an image pattern having image pattern structures therein. After identifying the image areas and the image pattern, the image areas are modified with a periodic image pattern structure to generate converted image areas. The converted image areas are then merged with the digital image to produce an output digital image where the toner of each image area is deposited on the image structures within the image areas.

### BRIEF DESCRIPTION OF THE DRAWINGS

The foregoing aspects and other features of the present invention are explained in the following description, taken in connection with the accompanying drawings, wherein:

FIG. 1 is a schematic diagram of an exemplary electrophotographic printing or imaging apparatus incorporating features of the present invention;

FIG. 2 is schematic of a hybrid scavengeless development station that can incorporate features of the present invention;

FIG. 3a is a graph of the charge pattern/voltage profile of an image area after being developed without the applied periodic structure;

FIG. 3b is a graph of the charge pattern/voltage profile of an image area as provided for in one embodiment of the present invention;

FIG. 4 is a partial illustration of a photoreceptor surface having small toner particles arranged in random order;

FIG. 5 is a partial illustration of a photoreceptor surface having toner particles as shown in FIG. 4 arranged in a predetermined periodic pattern;

FIG. 6 is one embodiment of a block diagram showing processing components of an image processor controller;

FIG. 7 is a block diagram showing particular details of processing components within the image processor controller of FIG. 6;

FIG. 8 is a partial side view of one embodiment of a feature of the present invention illustrating a flexible vibrating donor belt for transferring toner particles to the photoreceptor belt.

### DETAILED DESCRIPTION OF THE PREFERRED EMBODIMENT(S)

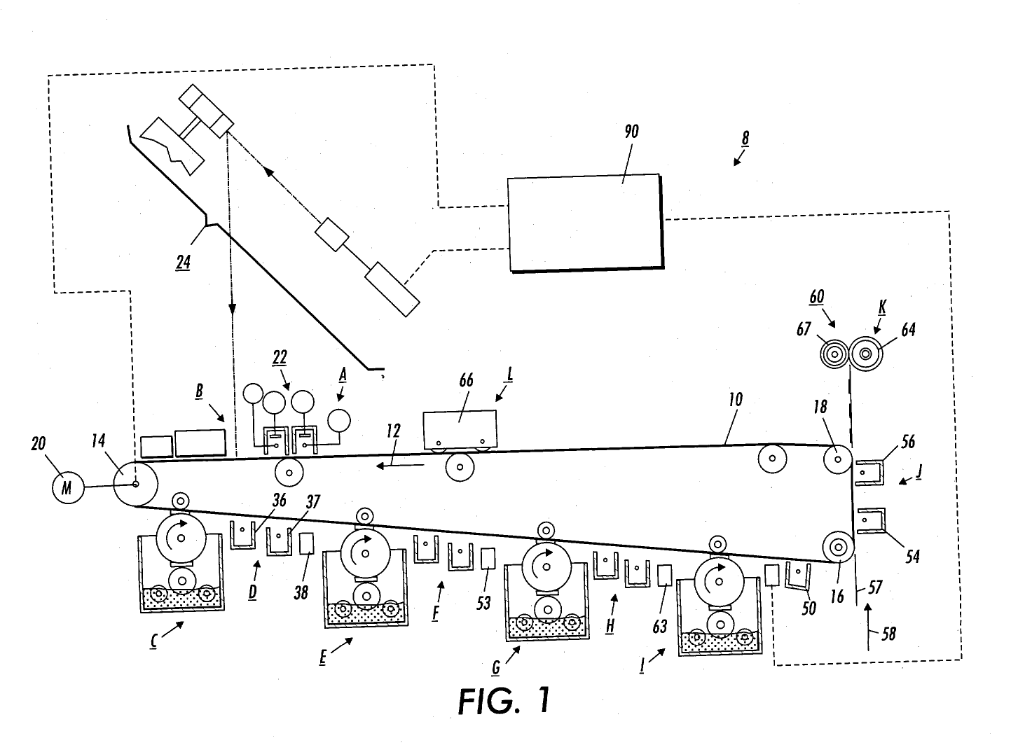

Referring to FIG. 1, a schematic illustration of an exemplary electrographic printing machine that can incorporate features of the present invention is shown. Although the present invention will be described with reference to the embodiment shown in the drawings, it should be understood that the present invention can be embodied in many alternate forms of the described embodiments. In addition, any suitable size, shape or type of elements or materials could be used with the invention as described herein.

The disclosed embodiments generally provide image processing designed to achieve a uniform distribution of toner particles on the photoreceptor of a xerographic apparatus after toner deposition. Generally, in one embodiment, charge patterns are created in regions that are to be developed as a solid area. A periodic charge structure is written on a photoreceptor with the ROS. The toner particle distribution confirms to the charge pattern distribution. An acoustic assist can also be used to achieve this distribution. The uniform distributions will allow for the use of larger more highly pigmented toner particles which will in turn provide better document appearance as the perceived uniformity will be greater and the image gloss less.

FIG. 1 is generally illustrative of a electrophotographic printing system. Although the present invention is described with respect to such an apparatus, it should be understood that any suitable printing apparatus can be used where electrical characteristics are used to distribute toner particles. It is a feature of the present invention to achieve a uniform distribution of toner particles on a photoreceptor (“PR”) of a printing apparatus after toner deposition.

As shown in FIG. 1, the electrophotographic printing system generally incorporates a photoreceptor 10 in the form of a belt having a photoconductive surface layer on an electroconductive substrate located on a flexible support member such as a Mylar™ belt. Preferably the surface is made from an organic photoreceptor. The substrate is preferably made from a conductive metal oxide which is electrically grounded. The belt is driven by means of motor 20 along a path defined by rollers 14, 16 and 18, the direction of movement being counter-clockwise as viewed and as shown by arrow 12. Initially a portion of the belt 10 passes through a charge station A at which a corona generator 22 charges surface to a relatively high, substantially uniform, potential. A high voltage power supply (not shown) is coupled to device 22. After charging, the charged area of surface is passed to exposure station B.

One example of such a electrophotographic printing system is illustrated in U.S. Pat. No. 5,666,619, assigned to the assignee of the present invention, the disclosure of which is incorporated herein by reference in its entirety.

As shown in FIG. 1, the electrophotographic apparatus, i.e. machine 8 creates a color image in a single pass through the machine and incorporates the features of the present invention. The machine 8 uses a charge retentive surface in the form of an Active Matrix (AMAT) photoreceptor belt 10 that travels sequentially through various process stations in the direction indicated by the arrow 12. Belt 10 travel is brought about by mounting the belt about a drive roller 14 and two tension rollers 16 and 18, and then rotating the drive roller 14 via a drive motor 20 so that belt 10 moves in the direction of arrow 12.

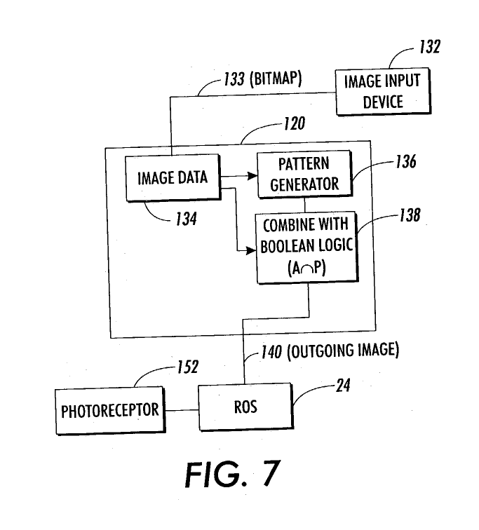

As the photoreceptor belt 10 moves, each part of it passes through each of the subsequently described process stations. For matters of convenience, a single section of the photoreceptor belt 10, referred to as the image area, is identified to the machine 8 by an image processor controller 120 as shown in FIG. 7. The image area is that part of the photoreceptor belt 10 that is to receive the toner powder which, after being transferred to a substrate, such as plain paper, produces the final image. While the photoreceptor belt 10 may have numerous image areas, since each image area is processed in the same way, a description of the typical processing of one image area suffices to fully explain the operation of printing machine 8.

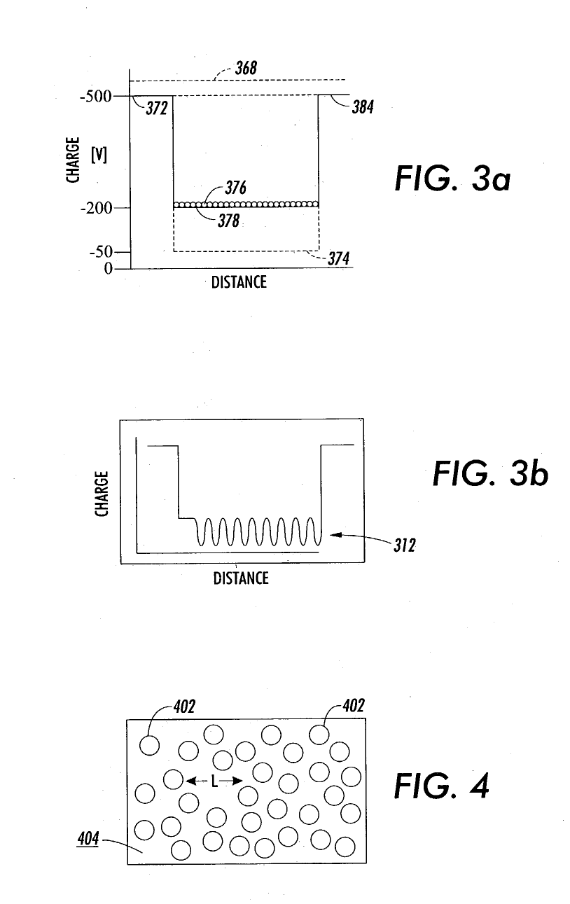

As the photoreceptor belt 10 moves in the direction of arrow 12, the image area passes through a charging station A. At charging station A, a corona generating device, indicated generally by the reference numeral 22, charges the image area to a relatively high and substantially uniform potential. FIG. 3a illustrates a typical voltage profile as a dashed line of an image area after that image area has left the charging station A. As shown, the image area has a uniform potential of about −500 volts. In practice, this is accomplished by charging the image area slightly more negative than −500 volts so that any resulting dark decay reduces the voltage to the desired −500 volts. While FIG. 3a shows the image area as being negatively charged, it could be positively charged if the charge levels and polarities of the toners, recharging devices, photoreceptor, and other relevant regions or devices are appropriately changed.

After passing through the charging station A, the now charged image area passes through a first exposure station B. At the first exposure station B, the charged image area is exposed to light that illuminates the image area with a light representation of a first color (for example, black) image. That light representation discharges some parts of the image area so as to create an electrostatic latent image. While the illustrated embodiment uses a laser based output scanning device (ROS) 24 as a light source, it is to be understood that other light sources, for example, an LED printbar, can also be used with the principles of the present invention. A voltage level 72 after exposure in the first exposure station B is about −500 volts on those parts of the image area that were not illuminated while a voltage level 74 of about −50 volts, exists on those parts that were illuminated. Thus, after exposure, the image area has a voltage profile comprised of relatively high and low voltages.

After passing through the first exposure station B, the now exposed image area passes through a first development station C that is identical in structure with development stations E, G, and I. The first housing can be interactive, and thus does not have to be “scavengeless.” For purposes of this description, all four development stations are assumed to be of a non-interactive hybrid scavengeless nature, and all are assumed to be identical in physical configuration. The first development station C deposits a first color, say, for example, black, of negatively charged toner onto the image area. That toner is attracted to the less negative section of the image area and repelled by the more negative sections. The result is a first toner powder image on the image area.

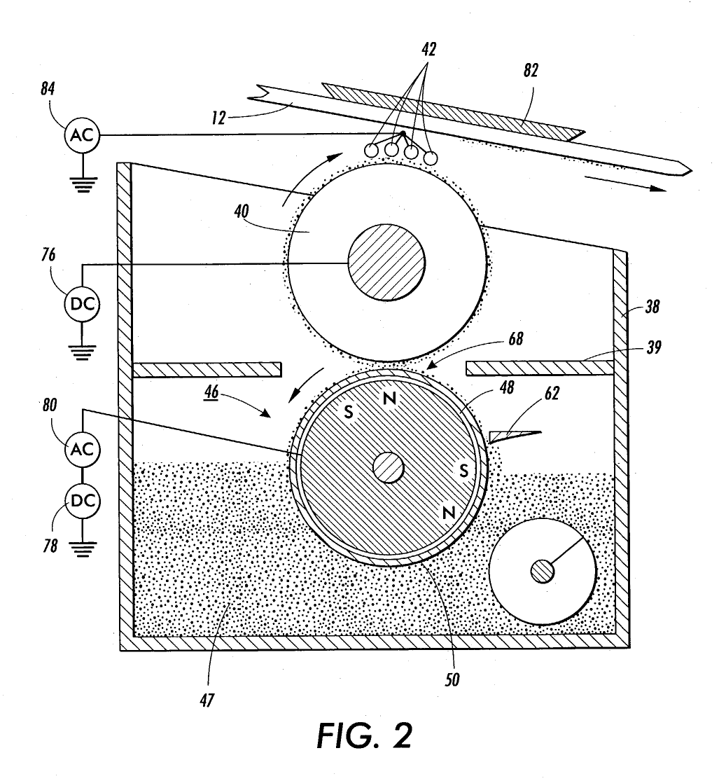

FIG. 2 shows a hybrid-scavengeless development system in greater detail. Housing 38 defines a chamber for storing a supply of developer material 47 therein. A housing shelf 39 separates the developer housing into two sections; one associated with the donor roll and the other associated with the transport roll 46. Positioned in the bottom of housing 38 is a horizontal auger which distributes developer material uniformly along the length of transport roll 46, so that the lowermost part of roll 46 is always immersed in a body of developer material.

Transport roll 46 comprises a stationary multi-polar magnet 48 having a closely spaced sleeve 50 of non-magnetic material, preferably aluminum, designed to be rotated about the magnetic core 48 in a direction indicated by the arrow. Because the developer material includes magnetic carrier granules, the effect of the sleeve rotating through stationary magnetic fields is to cause developer material to be attracted to the exterior of the sleeve. A doctor blade 62 is used to limit the radial depth of developer remaining adherent to sleeve 50 as it rotates to the nip 68 between transport roll 46 and donor roll 40. The donor roll is kept at a specific voltage, by a DC power supply 76, to attract a thin layer of toner particles from transport roll 46 in nip 68 to the surface of donor roll 40. Either the whole of the donor roll 40, or at least a peripheral layer thereof, is preferably of material which has low electrical conductivity. The material must be conductive enough to prevent any build-up of electric charge with time, and yet its conductivity must be low enough to form a blocking layer to prevent shorting or arcing of the magnetic brush to the donor roll.

Transport roll 46 is biased by both a DC voltage source 78 and an AC voltage source 80. The effect of the DC electrical field is to enhance the attraction of developer material to sleeve 50. It is believed that the effect of the AC electrical field applied along the transport roll in nip 68 is to loosen the toner particles from their adhesive and triboelectric bonds to the carrier particles. AC voltage source 80 can be applied either to the transport roll as shown in FIG. 2, or directly to the donor roll in series with supply 76.

Electrode wires 42 are disposed in the space between the belt 10 and donor roll 40. Four electrode wires are shown extending in a direction substantially parallel to the longitudinal axis of the donor roll 40. The electrode wires are made from of one or more thin (i.e. 25 to 125 micron diameter) steel, stainless steel or tungsten wires which are closely spaced from donor roll 40. The diameter of the wires shown in the figures is greatly exaggerated compared to the real wires for illustrative purposes. The distance between the wires and the donor roll 40 is approximately the thickness of the toner layer formed on the donor roll 40, or less. The wires are self-spaced from the donor roller by the thickness of the toner on the donor roller. The wire is supported in close proximity to the ends of the donor roll. This support locates the wires such that the wire and donor roll end maintain a specific required angular relationship. An alternating electrical bias is applied to the electrode wires by an AC voltage source 84. The applied AC establishes an alternating electrostatic field between the wires and the donor roller which is effective in detaching toner from the surface of the donor roller and forming a toner cloud about the wires.

The various machine functions described above can generally be managed and regulated by a controller 90 of FIG. 1 that proves electrical command signals for controlling the operation described above and is as further described below. Another printing system that can incorporate features of the present invention is illustrated in U.S. Pat. No. 5,754,930, the disclosure of which is incorporated herein by reference in its entirety.

FIG. 3a shows the charge pattern/voltages on the image area after the image area passes through a development station. Toner 376 adheres to the illuminated image areas being at a more positive voltage. This causes the voltage in the illuminated area to decrease to, for example, about −200 volts, as represented by the solid line 378. The un-illuminated parts of the image area remain at about the level 372 that repels the toner particles.

Referring now specifically to FIGS. 3a and 4, the toner 376 of FIG. 3a attaches to the less negatively charged area at the voltage level 374 of FIG. 3a. The resulting image is shown in FIG. 4 with the random distribution of toner. This image area 404 may be sufficiently small so that variations or different concentrations in the deposition of toner particles 402 may not be noticeable to the eye. If the area 404 is larger, different concentrations of the toner particles 402 will become evident. If one attempts to lower the toner particle size to 5 microns from a nominal size of approximately 10 to 12 microns, as disclosed in U.S. Pat. No. 6,071,665 the disclosure of which is incorporated herein by reference, more toner material would be needed in an attempt to insure a more uniform appearance. The fuser K (See FIG. 1) will be able to spread the toner particles so that the spaces between the particles are a minimum thereby reducing the amount of the non-uniformity. Furthermore, the spatial frequency of the non-uniformity, if it occurs, because of non-uniform distribution, is in a region where the eye is less responsive. The spatial frequency of the non-uniformity would be more easily perceived by the eye. Due to manufacturing considerations and various safety concerns, a larger diameter toner particle is desired such as a toner particle having a diameter of about 10 microns or greater. Using larger diameter toner particles in image area 404 can increase the likelihood of non-uniformity in appearance.

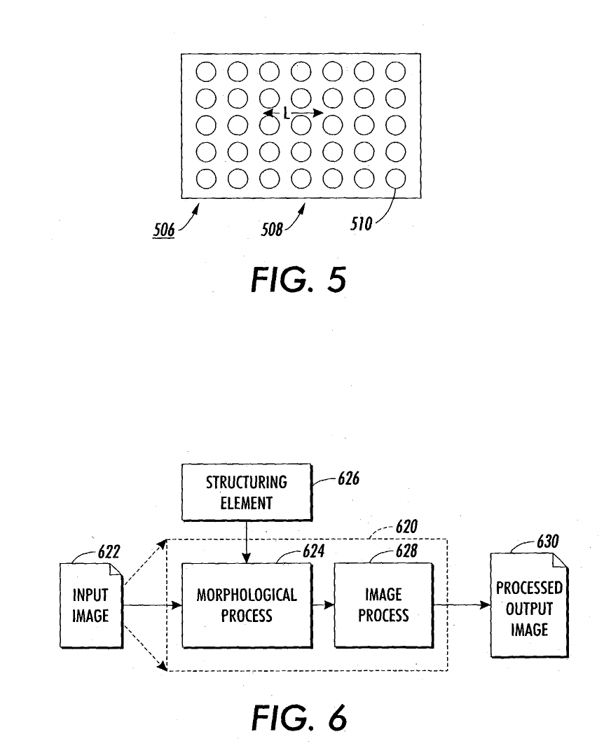

The ROS 24 of FIG. 1 creates the image structures 312 shown in FIG. 3b. Referring to FIGS. 3b and 5, the ROS 24 is adapted to create a pattern 312 of converted image areas as shown in FIG. 3b. The converted image area 312 of FIG. 3b, only partially shown, can comprise two dimensional patterns of image structures 312 in FIG. 3b, such as for example, dots, squares, or other like structures. Each image structures 312 in FIG. 3b is placed in the image area upon the photoreceptor belt 10 by the ROS 24 or other device that is defined by, for example, the controller 90. The diameter of the image structures of FIG. 3b is a parameter that may be varied. The ROS 24 places the image structures 312 of FIG. 3b in the image area 508 of FIG. 5 as defined by the controller 90. Thus, rather than having a uniform latent image where the toner particles would randomly attach as noted in FIGS. 3a and 4, the latent image would be composed of a plurality of the image structures 510 of FIG. 5 upon which the toner particles would be attached while in each of the development stations as noted above. In FIG. 5, the pattern 508 formed by the image structures 510 may appear as a square grid, a rectangular grid, or other suitable grid patterns.

Referring to FIG. 3b, the charge pattern/voltage level 312 shows a sinusoidal variation, rather than the fixed voltage level 374 of FIG. 3a. The charge pattern of FIG. 3b results in a periodic pattern of image structures 510 on the photoreceptor belt 10. Although a sinusoidal pattern is illustrated, any suitable pattern can be used. An electrostatic and an acoustic means can be used to achieve the uniform toner distributions. The electrostatic technique takes advantage of the ability of laser xerography to write almost arbitrary patterns on the photoreceptor. The toner particles would attach to the more positive voltage areas on the image area of the belt 10, thus creating a pattern as shown in FIG. 5. The periodicity of the image structure would normally dictate the image quality. In one embodiment, one or two dimensional charge patterns, such as that shown in FIG. 3b, are created in regions that are to be developed as solid areas. The contrast of these patterns may be small. The electrostatic driving forces on the toner force development in a regular array, such as that shown in FIG. 5. It is further within the scope of the present invention to change the diameter of the image structures 510 based on the toner color and the spacing between the image structures 510. The present invention can also be incorporated in a color printing or imaging apparatus.

In alternate embodiments, an acoustic assist can be used to achieve more uniform distributions. In this embodiment, the acoustical signal will allow the toner particles to move around more freely on the surface and approach the electrostatic equilibrium of uniform spacing and responsiveness to the electrostatic fields generated by the charge patter shown in FIG. 3b.

In one embodiment, a color picture, for example, to be copied may have numerous image areas to be identified as to size, location, color, or other factors considered when printing the picture. Referring to FIG. 6, an image processing controller 620 receives an image 622 that may comprise a bitmap. The image 622 is input into a morphological processor 624 that identifies or filters or isolates particular structures within a digital image. In one embodiment, the structures of concern would be two dimensional image areas having essentially one solid color. An image processing block 628 receives the identified structures in the image from the morphological process block 624 and further process the image to insert therein a predetermined pattern 628 of image structures 510 of FIG. 5. A converted image area 506 such as shown in FIG. 5 is generated that results in a processed output image 630.

FIG. 7 illustrates one embodiment of an imaging machine 8 for printing a color image (not shown). An image input device 132 within the imaging machine 8 of FIG. 1 produces a bitmap 133 of an image. This bitmap 133 is input into the controller 120 being, for example, a computer or microprocessor. For each color, a bitmap is generated based on the identified image areas. The desired image pattern structures 510 shown in FIG. 5 and pattern are defined in the pattern generator 136.The pattern 508 of FIG. 5 is incorporated into the image area 506 for each of the toner colors by the logic 138 as shown in FIG. 7. Each converted image 506 in FIG. 5 is then transmitted to the ROS 24 and the photoreceptor 152 of FIG. 7. It should be understood that each image from a picture, for example, may have numerous image areas for the particular toner colors and that each image area is changed into a converted image where the converted image structures 510 of FIG. 5 are the only objects being written to the photoreceptor belt 10 of FIG. 1 for toning.

An output of the image data 134 and the pattern generator 136 can be combined using Boolean logic, for example, in block 138 to insert the image structures 510 of FIG. 5 into the image area 106 as being noted as the intersection of the two images A and P. This converted image is then output by block 138.

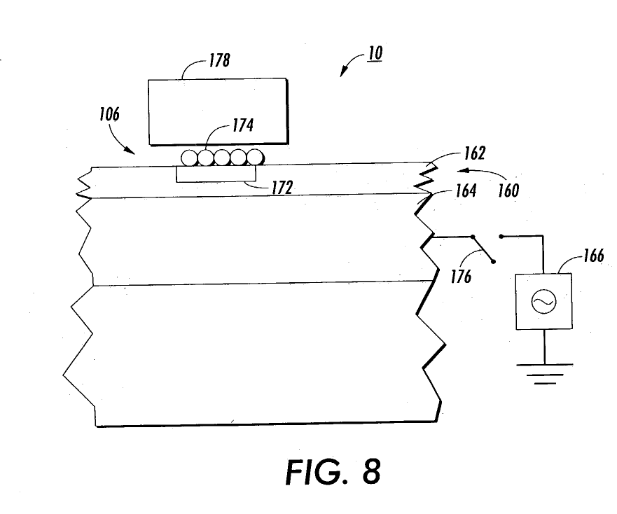

Referring to FIG. 8, to insure that the toner particles 174 are adhered to an image structure 172 (only one shown) on the photoreceptor belt 10 of FIG. 1 and not to other undesired locations within the image area 506 (FIG. 5), a vibrating device being an acoustic-device 178 or an electromechanical device 160 supplies a sufficient amount of vibration energy to the toner particles 174 so that ones not located properly on the latent image structures 172 may be removed by gravitational effects, blowing air, brushes, or by other means. This will allow the toner particles to move around more freely on the surface and thus approach the electrostatic equilibrium of the uniform spacing resulting from the electrostatic fields generated by the charge pattern 508 (FIG. 5).

The acoustical device 178 outputs sound waves of a predetermined frequency and energy by conventional means that impact on the toner particles 174. The acoustical device 178 may be located after each development station and before the recharging stations, for example, or may be positioned near the transfer station J.

The electromechanical device 160 may be a piezoelectric transducer element 164 incorporated into the photoreceptor belt 10 (FIG. 1) under the charge retentive surface 162. The piezoelectric transducer element is driven by a generator 166 through a switch 176 and may output a frequency in the range from 20 kHz to 200 kHz, for example. U.S. Pat. No. 6,219,515 which is incorporated by reference specifically as to the piezoelectric transducer used to affect the distribution of toner particles in the imaging process. The operation of the transducer element 164 may only occur in an area such as near or at the transfer station J in order to minimize any interference with the writing of the image information to the photoreceptor belt 10 (FIG. 1) at the various exposure stations. A plurality of the transducer elements 164 may be located along the belt length and have appropriate electrical contacts for each activating each element 164.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A method for processing a digital image for printing by an image machine comprising:
identifying image areas associated with a toner;
identifying an image pattern having image pattern structures therein;
modifying the image areas with a periodic image pattern structure to generate converted image areas; and
merging the converted image areas with the digital image to produce an output digital image where the toner of each image area is deposited on the image structures within the image areas.

2. A method for processing an image as defined in claim 1 wherein the step of identifying an image pattern includes applying a morphological process to the digital image.

3. A method for processing an image as defined in claim 2 wherein the morphological process identifies positive image area structures.

4. A method for processing an image as defined in claim 3 wherein the image pattern structures are positive image pattern structures.

5. A method for processing an image as defined in claim 4 wherein the image pattern structures are selected from the group consisting of circles, squares and rectangles.

6. A method for processing an image as defined in claim 4 wherein both the positive image area structures and the image pattern structures are converted to image areas having only the image pattern structures therein.

7. A method for processing an image as defined in claim 1 wherein the method is applied during the image-on-image color printing process.

8. A method for processing an image as defined in claim 1 wherein a toner has particles of sizes ranging from about 8 to about 12 microns.

9. A method for processing an image as defined in claim 1 further including an application of vibratory energy to each toner applied to the output digital image before a step of fusing the toners to a support sheet.
